(19) United States
(12) Patent Application Publication
(10) Pub. No.: US 2005/0005804 A1
(43) Pub. Date: Jan. 13, 2005

(54) Coloring book and apparatus and method to form

(76) Inventor: Gerald Nathanson, Tucson, AZ (US)

Correspondence Address: Dale F. Regelman;Law Office of Dale F. Regelman, P.C., 4231 S. Fremont Avenue, Tucson, AZ, 85714, US

(21) Appl. No.: 10/888,703

(22) Filed: Jul. 9, 2004

Related U.S. Application Data
(60) Provisional application No. 60/485,776, filed on Jul. 9, 2003.

(51) Int. Cl. B41F 31/00

(52) U.S. Cl. 101/491; 281/15.1

(57) ABSTRACT

A coloring book and method and apparatus form same are disclosed. The method provides a plurality of flexible substrates, and a printing press comprising a reservoir, a plurality of distribution rollers, two form rollers, a printing plate comprising one or more raised portions, but no cooling apparatus. The method disposes a water-soluble ink in the reservoir, and conveys that water-soluble ink from the reservoir onto the one or more raised portions using the plurality of distribution rollers and the two form rollers. The method then disposes the water-soluble ink from the printing plate onto a different one of the plurality of flexible substrates at a rate of about 6,000 impressions per hour.

### FIELD OF THE INVENTION

This invention relates to coloring books, color tablets, educational coloring materials, or similar articles having image areas for coloring by a user

### BACKGROUND OF THE INVENTION

Various products including coloring books and paint-by-number drawings have printed drawings on a paper substrate with specific areas intended to be colored or painted a specific color by the user. Such products would be enhanced by providing a source of water-soluble inks to be used in the coloring process. What is needed is a method to produce coloring books and the like that include one or more coloring outlines in combination with a color palette, where that color palette includes a plurality of water-soluble inks each having a pigment.

Traditional printing apparatus and methods utilize a printing press that includes a plurality of moving parts which generate heat during use. Such conventional apparatus and methods cool the various parts of the printing press using water. Use of such cooling water necessarily precludes using water-soluble inks. Applicants' method comprises a high speed printing process that utilizes water-soluble inks, and does not require water cooling.

### SUMMARY OF THE INVENTION

Applicants' invention includes a method to form a coloring book, or the like. Applicant's method provides a plurality of flexible substrates, and a printing press comprising an ink reservoir, a plurality of distribution rollers, two form rollers, a printing plate comprising one or more raised portions, but no cooling apparatus. Applicant's method disposes a water-soluble ink in the reservoir, and conveys that water-soluble ink from the reservoir onto the one or more raised portions using the plurality of distribution rollers and the two form rollers. Applicant's method then disposes the water-soluble ink from the printing plate onto a different one of the plurality of flexible substrates at a rate of about 6,000 impressions per hour.

### BRIEF DESCRIPTION OF THE DRAWINGS

The invention will be better understood from a reading of the following detailed description taken in conjunction with the drawings in which like reference designators are used to designate like elements, and in which:

FIG. 1 is a top view of a flexible substrate formed using Applicant's method, where that flexible substrate includes a coloring outline and a color palette;

FIG. 2 is a flow chart summarizing the steps of Applicant's method;

FIG. 3 is a block diagram showing a prior art printing apparatus; and

FIG. 4 is a block diagram showing Applicant's printing apparatus.

### DETAILED DESCRIPTION OF THE PREFERRED EMBODIMENTS

This invention is described in preferred embodiments in the following description with reference to the Figures, in which like numbers represent the same or similar elements.

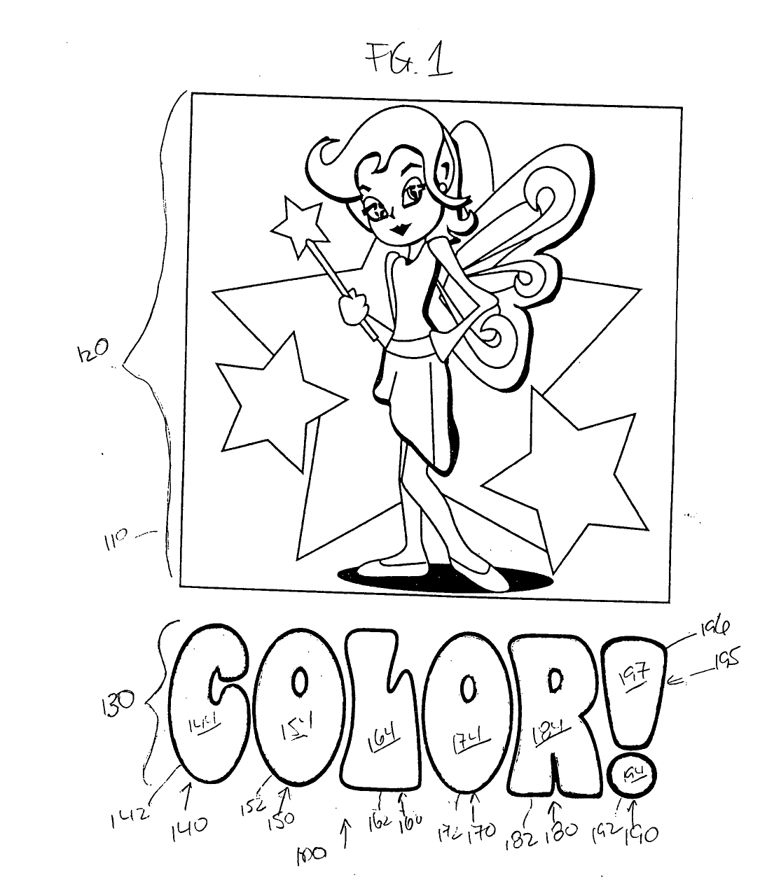

Applicants' invention includes a flexible substrate comprising a pigmented, graphically design. FIG. 1 shows one embodiment of Applicants' invention. The illustrated embodiment of FIG. 1 comprises substrate 110, coloring outline 120, and plurality of color palettes 130. Substrate 110 is selected from the group which includes paper, plastic film, a metal foil, and combinations thereof.

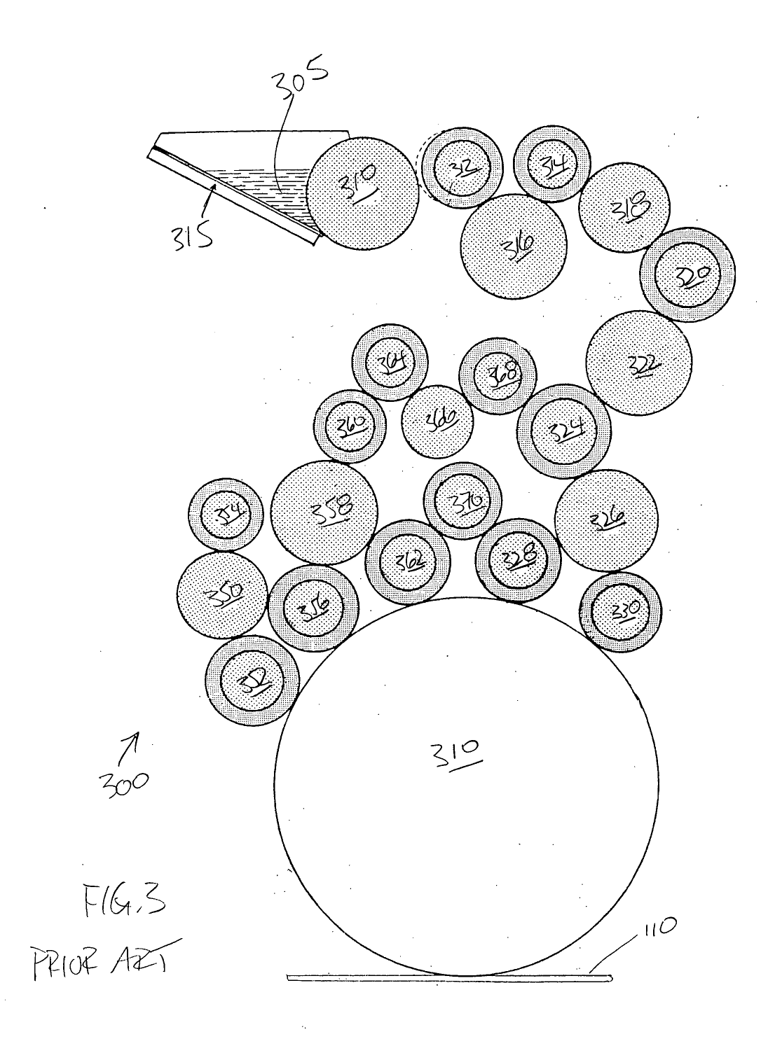

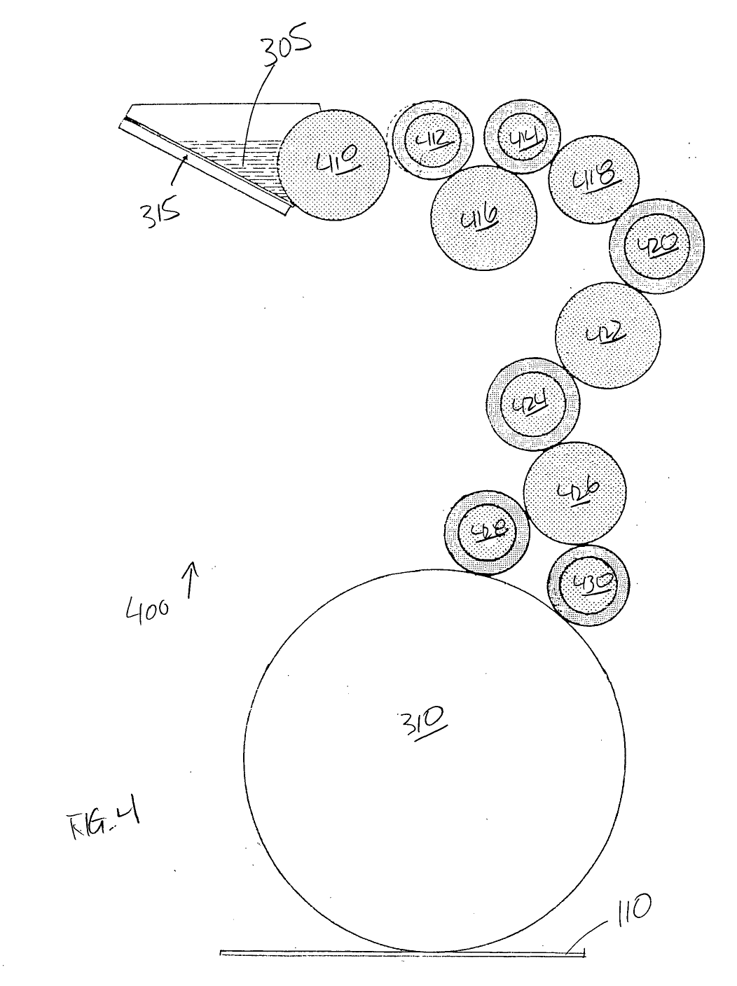

In certain embodiments, coloring outline 120 is disposed onto substrate 110 using water-insoluble black ink and the printing press configuration of FIG. 3. In certain embodiments, coloring outline 120 is disposed onto substrate 110 using water-insoluble black ink and the printing press configuration of FIG. 4. In certain embodiments, the plurality of color palettes 130 is disposed onto substrate 110 using a plurality of water-soluble, pigmented inks and the printing press configuration of FIG. 4.

In the illustrated embodiment of FIG. 1, plurality of color palettes 130 comprises seven features, namely feature 140 comprising the letter “C”, feature 150 comprising the letter “O”, feature 160 comprising the letter “L”, feature 170 comprising the letter “O”, feature 180 comprising the letter “R”, feature 190 comprising the circular portion of an exclamation point, and feature 195 comprising the elongated portion of an exclamation point.

Feature 140 includes color palette outline 142 and color palette 144, where that color palette 144 is formed using a first water-soluble ink, where that first water soluble ink comprises a first pigment. In certain embodiments, that first pigment is selected from the group consisting of red, orange, yellow, green, blue, and purple.

Feature 150 includes color palette outline 152 and color palette 154, where that color palette 154 is formed using a second water-soluble ink, where that second water soluble ink comprises a second pigment. In certain embodiments, that second pigment is selected from the group consisting of red, orange, yellow, green, blue, and purple.

Feature 160 includes color palette outline 162 and color palette 164, where that color palette 164 is formed using a third water-soluble ink, where that third water soluble ink comprises a third pigment. In certain embodiments, that third pigment is selected from the group consisting of red, orange, yellow, green, blue, and purple.

Feature 170 includes color palette outline 172 and color palette 174, where that color palette 174 is formed using a fourth water-soluble ink, where that fourth water soluble ink comprises a fourth pigment. In certain embodiments, that fourth pigment is selected from the group consisting of red, orange, yellow, green, blue, and purple.

Feature 180 includes color palette outline 182 and color palette 184, where that color palette 184 is formed using a fifth water-soluble ink, where that fifth water soluble ink comprises a fifth pigment. In certain embodiments, that fifth pigment is selected from the group consisting of red, orange, yellow, green, blue, and purple.

Feature 190 includes color palette outline 192 and color palette 194, where that color palette 194 is formed using a sixth water-soluble ink, where that sixth water soluble ink comprises a sixth pigment. In certain embodiments, that sixth pigment is selected from the group consisting of red, orange, yellow, green, blue, and purple.

Feature 195 includes color palette outline 196 and color palette 197, where that color palette 197 is formed using a seventh water-soluble ink, where that seventh water soluble ink comprises a seventh pigment. In certain embodiments, pigment 199 is selected from the group consisting of red, orange, yellow, green, blue, and purple.

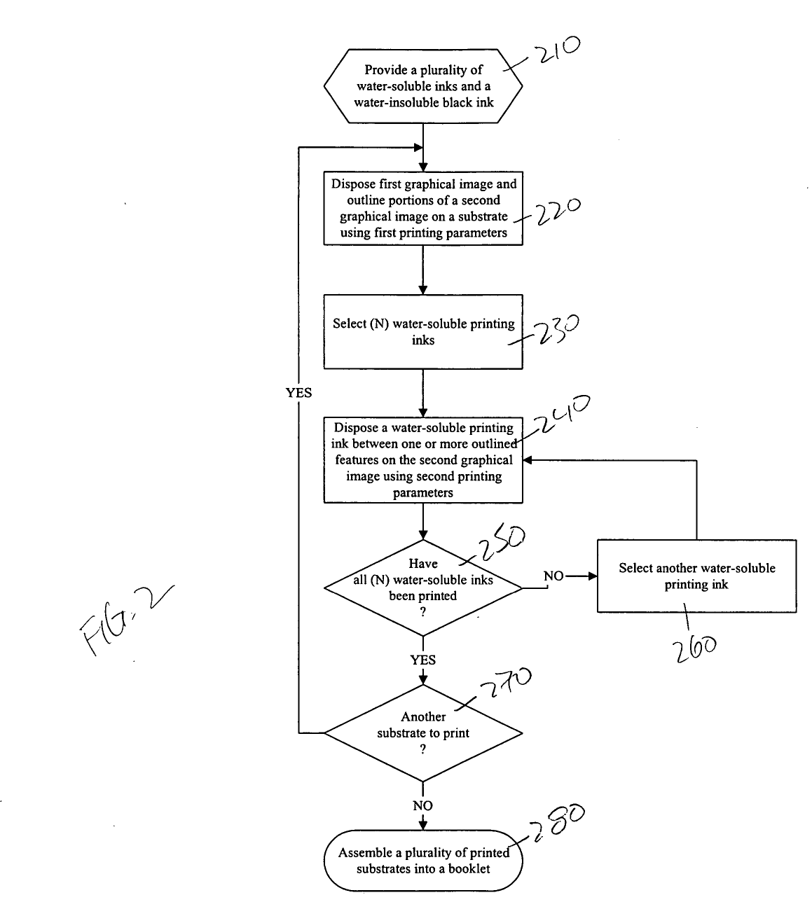

Applicants' invention includes a method to dispose graphical image 120 and graphical image 130 onto substrate 110. FIG. 2 summarizes the steps of Applicants' method. Referring now to FIG. 2, in step 210 the method provides a plurality of pigmented water-soluble inks and a water-insoluble ink.

In step 220, the method disposes a coloring outline, such as coloring outline 120 (FIG. 1), onto a substrate, such as substrate 110 (FIG. 1). The first graphical image of step 220 comprises one or more features printed in an outline format. Step 220 further includes printing the outline portions of one or more features comprising a second graphical image, such a graphical image 130 (FIG. 1). For example, in the illustrated embodiment of FIG. 1, step 220 includes printing color palette outlines 142, 152, 162, 172, 182, 192, and 196, onto substrate 110.

In certain embodiments, the printing of step 220 is performed using first printing parameters. Those first printing parameters include a first press configuration, a water cooling mechanism, and a first production rate. In certain embodiments, the first production rate is between about 8,000 to about 12,000 impressions per hour.

FIG. 3 is a block diagram showing first press configuration 300. First press configuration 300 is used to convey ink 305 from reservoir 345 to substrate 110. The first press configuration of FIG. 3 comprises total of 22 rollers and printing plate 310. As printing plate 310 rotates, that plate selectively disposes ink onto substrate 110. As those skilled in the art will appreciate, printing plate 310 includes one or more raised, ink-bearing regions. As plate 310 rotates, certain of those ink-bearing regions contacts substrate 110 and transfer ink to substrate 110.

The 22 rollers comprising first press configuration 300 include one or more form rollers, inductor rollers, distribution rollers, and vibrator rollers. A form roller, such as rollers 328, 330, 352, 356, and 362, apply ink onto one or more raised portions of printing plate 310. An inductor roller, such as roller 310, introduces ink from a source, such as reservoir 315 onto the roller chain. The distribution rollers, such as rollers 312, 314, 316, 318, 320, 322, 324, 354, 360, 364, 366, and 368, convey ink from the source to the form rollers. Vibrator rollers, such as rollers 326, 350, and 358, oscillate to provide a uniform distribution of the ink thereover.

As those skilled in the art will appreciate, as the printing press configuration of FIG. 3 operates, heat is generated. The first printing parameters of step 220 include a cooling mechanism. In certain embodiments of this cooling mechanism, water is disposed over one or more rollers to reduce the temperature of the roller chain.

Referring again to FIG. 2, in step 230 the method selects (N) water-soluble inks to dispose between the outlined features of the second graphical image, such as graphical image 130 (FIG. 1). In certain embodiments, (N) is 3. In certain embodiments, (N) is 4. In certain embodiments, (N) is 5. In certain embodiments, (N) is 6. In certain embodiments, (N) is 7. In certain embodiments, (N) is greater than 7. In certain embodiments, (N) is less than 3.

In step 240, the method prints one of the selected water-soluble, pigmented inks onto the substrate 110 (FIG. 1). For example, in one embodiment a red-colored, water-soluble ink is disposed within color palette outline 142 to form a red color palette 144 having border 142. The printing of step 240 is performed using second printing parameters.

The second printing parameters of step 240 include using a second printing press configuration, and a second production rate. In certain embodiments, the second production rate is between about 5,000 to about 6,000 impressions per hour. In certain embodiments, the second production rate is between about 0.5 and about 0.63 times the first production rate.

FIG. 4 is a block diagram showing second press configuration 400. Second press configuration 400 is used to convey ink 305 from reservoir 315 to substrate 110. The second press configuration of FIG. 4 comprises total of 11 rollers and printing plate 310. Second press configuration 400 includes rollers 410, 412, 414, 416, 418, 420, 422, 424, 426, 428, and 430. The roller chain of FIG. 4 includes only 2 form rollers, namely form rollers 428 and 430.

Applicant's second printing press configuration of FIG. 4 does not include a cooling mechanism. More specifically, water is not used to cool the rollers in the second printing press configuration of FIG. 4. Rather, the printing press using the second press configuration is simply housed in a work space maintained at normal room temperature, i.e. between about 70° F. and about 80° F.

In step 250, the method determines if all the (N) selected pigmented, water-soluble inks have been printed onto substrate 110. If the method determines in step 250 that not all the selected inks have been printed, then the method transitions from step 250 to step 260 wherein another pigmented, water-soluble ink is selected. The method transitions from step 260 to step 240 and continues.

If the method determines in step 250 that all the selected pigmented, water-soluble inks have been printed, then the method transitions from step 250 to step 270 wherein the method determines if additional pages remain to be printed. If Applicants' method determines that one or more additional pages remain to be printed, then another substrate is selected and the method transitions from step 270 to step 220 and continues.

If Applicants' method determines in step 270 that no additional page remain to be printed, then the method transitions from step 270 to step 280 wherein the method binds a plurality of printed pages together to form an article of manufacture comprising a plurality of pages each of which includes a first graphical image in outline and a printed color palette comprising a plurality of water soluble inks.

In certain embodiments, the first graphical image comprises a blank image. In these embodiments, the printed page formed using the steps of FIG. 2 comprises only a color palette which includes a plurality of individual features each comprising a different water-soluble ink. In these embodiments, Applicants' method does not include step 220.

In certain embodiments, Applicants' method is used to produce a single printed page. In these embodiments, Applicants' method ends after deciding “NO” in step 270.

Applicants' invention includes a method to transfer a plurality of water-soluble onto a first graphical image, such as coloring outline 120, from a second graphical image, such as such color palette 144. A portion of a first water-soluble ink is transferred from one of color palettes 144, 154, 164, 174, 184, 194, 197, onto an ink transfer device. The ink transfer device is then brought into contact with a portion of substrate 110 comprising the coloring outline, and the ink disposed on the ink transfer device is then disposed onto that contacted portion of substrate 110.

In certain embodiments, the ink transfer device comprises a conventional paint brush having a plurality of bristles disposed on one end. Those bristles are immersed into water to transfer/absorb a quantity of water onto/into the bristles. Those water-impregnated bristles are then brought into contact with the surface of a color palette. A plurality of water drops are disposed onto that contacted color palette. That plurality of water drops dissolve a portion of the water-soluble ink comprising the contacted color palette. One or more drops of colored water are then transferred/absorbed onto the paint brush.

The paint brush is then brought into contact with a portion of graphical image 120 such that one or more drops of colored water are transferred from the brush to substrate 110. This process is repeated to sequentially apply one or more of the water-soluble inks from one or more of the color palettes onto graphical image 120. Thereafter, the painted substrate is maintained at room temperature, or warmer, to allow the moisture remaining on the painted page to evaporation. After evaporation of that moisture, the painted substrate comprises a colored graphical image 120.

While the preferred embodiments of the present invention have been illustrated in detail, it should be apparent that modifications and adaptations to those embodiments may occur to one skilled in the art without departing from the scope of the present invention as set forth in the following claims.

1. A method to form a coloring book, comprising the steps of:
providing a first water-soluble ink comprising a first pigment;
providing a water-insoluble ink;
providing a flexible substrate;
disposing on a first portion of said flexible substrate using said water-insoluble ink a first image comprising a coloring outline;
disposing on a second portion of said flexible substrate using said water-insoluble ink a second image comprising a color palette outline;
disposing said first water-soluble ink within said color palette outline.

2. The method of claim 1, further comprising the steps of:
providing a second water-soluble ink comprising a second pigment;
disposing on a third portion of said flexible substrate using said water-insoluble ink a second color palette outline;
disposing said second water-soluble ink within said second color palette outline.

3. The method of claim 1, further comprising the steps of:
providing (N) water-soluble inks, wherein each of said (N) water-soluble inks comprises a pigment;
providing a water-insoluble ink;
providing a flexible substrate;
disposing on a first portion of said flexible substrate using said water-insoluble ink a coloring outline;
disposing on a second portion of said flexible substrate using said water-insoluble ink (N) separate color palette outlines;
disposing the (i)th water-soluble ink within the (i)th color palette outline, wherein (i) is greater than or equal to 1 and less than or equal to (N).

4. The method of claim 3, further comprising the steps of:
providing 5 water-soluble inks, wherein each of said 5 water-soluble inks comprises a different pigment;
disposing on a second portion of said flexible substrate using said water-insoluble ink 5 separate color palette outlines;
wherein the first color palette outline comprises the letter C, and wherein the second color palette outline comprises the letter O, and wherein the third color palette outline comprises the letter L, and wherein the fourth color palette outline comprises the letter O, and wherein the fifth color palette outline comprises the letter R.

5. The method of claim 1, further comprising the steps of:
providing a plurality of flexible substrates;
providing a printing press comprising a reservoir, a plurality of distribution rollers, two form rollers, and a printing plate comprising one or more raised portions, and no cooling apparatus;
disposing said water-soluble ink in said reservoir;
conveying said water-soluble ink from said reservoir onto said one or more raised portions using said plurality of distribution rollers and said two form rollers;
disposing said water-soluble ink from said printing plate onto a different one of said plurality of flexible substrates at a rate of about 6,000 impressions per hour.

6. The method of claim 5, further comprising the step of disposing said printing press in a work space having a temperature of between about 70° F. and about 80° F.

7. A coloring book, comprising:
a flexible substrate;
a coloring outline formed using a water-insoluble ink disposed on a first portion of said flexible substrate;
a color palette formed using a water-soluble ink disposed on a second portion of said flexible substrate;
wherein said coloring book is formed by the process of:
providing a plurality of flexible substrates;
providing a printing press comprising a reservoir, a plurality of distribution rollers, two form rollers, and a printing plate comprising one or more raised elements, and no cooling apparatus;
disposing said water-soluble ink in said reservoir;
conveying said water-soluble ink from said reservoir onto said one or more raised portions using said plurality of distribution rollers and said two form rollers;
disposing said water-soluble ink from said printing plate onto a different one of said plurality of flexible substrates at a rate of about 6,000 impressions per hour.

8. The coloring book of claim 7, further comprising:
(N) separate color palette outlines disposed on said second portion of said flexible substrate formed using said water-insoluble ink;
(N) color palettes each comprising a pigmented water-soluble ink, wherein the (i)th water-soluble ink is disposed within the (i)th color palette outline, wherein (i) is greater than or equal to 1 and less than or equal to (N).

9. The coloring book of claim 8, further comprising (M) flexible substrates, wherein each of said (M) flexible substrates comprises a coloring outline formed from a water-insoluble ink in combination with a plurality of color palettes, wherein each color palette is formed from a water-soluble ink comprising a pigment.
